(19) United States
(12) Patent Application Publication
(10) Pub. No.: US 2007/0239936 A1
(43) Pub. Date: Oct. 11, 2007

(54) Method and apparatus for statistically modeling a processor in a computer system

(76) Inventor: Ilya Gluhovsky, Daly City, CA (US)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/601,030

(22) Filed: Nov. 17, 2006

Related U.S. Application Data
(60) Provisional application No. 60/789,963, filed on Apr. 5, 2006.

(51) Int. Cl. G06F 12/00

(52) U.S. Cl. 711/118

(57) ABSTRACT

One embodiment of the present invention provides a system that models computer system performance. The system empirically obtains a statistical model which comprises sets of statistical distributions for at least two types of memory-reference-related events associated with a workload executing on a processor in a computer system. These sets of statistical distributions include a first set of statistical distributions which characterize a distance between consecutive cache misses, and a second set of statistical distributions which characterize a distance between a cache miss and the beginning of a processor stall caused by the cache miss. The system then uses the statistical model to simulate the performance of the computer system executing the workload.

### Related Application

This application hereby claims priority under 35 U.S.C. §119 to U.S. Provisional Patent Application No. 60/789,963, filed on 5 Apr. 2006, entitled “Method for Evaluating Opteron Based System Designs,” by inventor Ilya Gluhovsky (Attorney Docket No. SUN06-0729-US-PSP).

### BACKGROUND

1. Field of the Invention

The present invention relates to techniques for modeling the performance of computer systems. More specifically, the present invention relates to a method and an apparatus that models computer system performance based on statistical distributions of memory-reference-related events.

2. Related Art

Advances in semiconductor fabrication technology have given rise to dramatic increases in microprocessor clock speeds. This increase in microprocessor clock speeds has not been matched by a corresponding increase in memory access speeds. Hence, the disparity between microprocessor clock speeds and memory access speeds continues to grow, which can cause performance problems. Execution profiles for fast microprocessor systems show that a large fraction of execution time is spent not within the microprocessor core, but within memory structures outside of the microprocessor core. This means that the microprocessor systems spend a large fraction of time waiting for memory references to complete instead of performing computational operations.

Hence, memory system design is becoming an increasingly important factor in determining overall computer system performance. In order to optimize memory system design, it is desirable to be able to simulate the performance of different memory system designs without actually having to build the different memory systems.

A cycle-accurate simulation simulates the behavior of a proposed memory-system design by applying sequences of memory references to a model of the design to simulate how a real processor would execute the memory references. This technique can typically generate precise simulation results. Unfortunately, cycle-accurate simulations suffer from a number of problems: (1) Speed: processing a large workload to simulate the performance of a hypothetical memory-system design and collecting a complete and detailed output is a time-consuming process; (2) Scalability: the simulation complexity does not scale well with multiple processors and multiple threads per processor; and (3) Storage: the output traces are typically very large, potentially consuming gigabytes of storage space.

To avoid these problems during early stages of designing a shared memory multiprocessor, high-level models are regularly used to explore a broad spectrum of design options. While these high-level models do not provide the precision of cycle-accurate simulations, the speed of the high-level models is particularly useful for culling large design spaces and resolving gross architectural tradeoffs. A cycle-accurate simulation can subsequently be used for detailed studies of small selected regions.

High-level models typically provide a suitable abstraction of system components and the way in which these components interact with a given workload. For example, a well-known model provides a memory system abstraction which describes cache miss rates corresponding to a given workload. More specifically, this memory system model receives a set of cache miss rates as inputs and generates and routes memory system requests probabilistically based on these rates. Note that a simple in-order processor stalls as soon as a cache miss occurs and then waits until the requested data is returned. Hence, this process for an in-order processor can be accurately described by the cache miss rates and infinite-cache execution speed.

However, an out-of-order processor can continue executing after a cache miss is issued and can potentially issue additional misses before stalling. As a result, the cache miss rates alone are not adequate to describe the performance of an out-of-order processor because the impact of a miss on the execution time now depends on how long the processor can execute past a first miss and on how many additional misses it can issue before stalling.

Several high-level models for out-of-order processors have been proposed. However, these high-level models make certain assumptions to keep the model simple. Unfortunately, these assumptions tend to oversimplify the modeled memory-system behavior, which compromises the accuracy of the performance results.

Hence, what is needed is a method and an apparatus for modeling a memory-system design efficiently without compromising the accuracy of the performance results.

### SUMMARY

One embodiment of the present invention provides a system that models computer system performance. The system empirically obtains a statistical model which comprises sets of statistical distributions for at least two types of memory-reference-related events associated with a workload executing on a processor in a computer system. These sets of statistical distributions include a first set of statistical distributions which characterize a distance between consecutive cache misses, and a second set of statistical distributions which characterize a distance between a cache miss and the beginning of a processor stall caused by the cache miss. The system then uses the statistical model to simulate the performance of the computer system executing the workload.

In a variation on this embodiment, the system empirically obtains the sets of statistical distributions by: (1) receiving a cycle-accurate simulator for the processor endowed with a generic main memory; (2) performing a cycle-accurate simulation of the workload executing on the cycle-accurate simulator to generate trace records for the memory-reference-related events; (3) collecting a set of sample values for each type of memory-reference-related event from the trace records; and (4) constructing a statistical distribution for each type of memory-reference-related event from the set of sample values.

In a further variation on this embodiment, the system constructs the statistical distribution from the set of sample values by ranking the set of the sample values into a percentile distribution based on the magnitude of the sample values.

In a further variation, the system uses the statistical model to simulate the performance of the computer system executing the workload by randomly sampling from the percentile distribution.

In a further variation, the system uses the statistical model to simulate the performance of the computer system executing the workload by randomly sampling from the set of sample values.

In a variation on this embodiment, each set of statistical distributions includes statistical distributions for different types of memory references including: loads; instruction fetches; and stores.

In a variation on this embodiment, prior to using the statistical model to simulate the performance of the computer system, the system rescales the first set of statistical distributions for a new memory-subsystem configuration.

In a variation on this embodiment, the system uses the statistical model to simulate the performance of the computer system executing the workload by: sampling from the first set of statistical distributions to generate simulated cache misses; computing latencies for the simulated cache misses; and sampling from the second set of statistical distributions and using the computed latencies to determine stall times associated with the simulated cache misses.

In a further variation, the system computes the latency associated with a cache miss by: (1) obtaining cache miss rates for specific components in the memory subsystem of the computer system; (2) using the cache miss rates to select a specific component in the memory subsystem which is ultimately accessed by the cache miss; and (3) computing the latency based on the latency of the specific component.

In a variation on this embodiment, the system uses the obtained statistical model to simulate a multiprocessor with different memory-subsystem configurations. These memory-subsystem configurations can differ in at least one of the following: number of cache levels; cache configuration in each cache level, which can further include (1) cache size; (2) cache associativity; (3) cache sharing; cache-coherence protocol; nonuniform memory access (NUMA) interconnect; and directory-based lookup.

In a variation on this embodiment, the system uses the obtained statistical model to simulate a multiprocessor implementing advanced architectural designs including: instruction prefetching; data prefetching; and runahead execution.

In a variation on this embodiment, the system uses the obtained statistical model to reproduce processor behavior whose stochastic characteristics match real execution.

In a variation on this embodiment, the system obtains a rate of execution of the processor in cycles per instruction (CPI) for the statistical model.

In a variation on this embodiment, prior to using the statistical model, the system corrects the second set of statistical distributions for censored data using a Kaplan-Meier technique.

### BRIEF DESCRIPTION OF THE FIGURES

FIG. 1 illustrates an exemplary computer system to be modeled in accordance with an embodiment of the present invention.

FIG. 2 presents a flowchart illustrating the process of producing statistical distributions for a high-level computer system model in accordance with an embodiment of the present invention.

FIG. 3 illustrates a simulated execution trace on a modeled memory-system configuration in accordance with an embodiment of the present invention.

FIG. 4 presents a flowchart illustrating the process of simulating the execution of a workload on a modeled memory-system configuration in accordance with an embodiment of the present invention.

FIG. 5A depicts a distribution for α_{ld} at different latencies under the TPCC workload in accordance with an embodiment of the present invention.

FIG. 5B depicts a distribution for α_{if} at different latencies under the TPCC workload in accordance with an embodiment of the present invention.

FIG. 5C depicts a distribution for αₛₜ at different latencies under the TPCC workload in accordance with an embodiment of the present invention.

FIG. 5D depicts a distribution for τ_{ld} at different latencies under the TPCC workload in accordance with an embodiment of the present invention.

FIG. 5E depicts a distribution for τ_{if} at different latencies under the TPCC workload in accordance with an embodiment of the present invention.

FIG. 5F depicts a distribution for τₛₜ at different latencies under the TPCC workload in accordance with an embodiment of the present invention.

FIG. 6A depicts a distribution for α_{ld} at different latencies under the SPECJBB workload in accordance with an embodiment of the present invention.

FIG. 6B depicts a distribution for α_{if} at different latencies under the SPECJBB workload in accordance with an embodiment of the present invention.

FIG. 6C depicts a distribution for αₛₜ at different latencies under the SPECJBB workload in accordance with an embodiment of the present invention.

FIG. 6D depicts a distribution for τ_{ld} at different latencies under the SPECJBB workload in accordance with an embodiment of the present invention.

FIG. 6E depicts a distribution for τ_{if} at different latencies under the SPECJBB workload in accordance with an embodiment of the present invention.

FIG. 6F depicts a distribution for τₛₜ at different latencies under the SPECJBB workload in accordance with an embodiment of the present invention.

FIG. 7A depicts a distribution for α_{ld} for different cache sizes under the TPCC workload in accordance with an embodiment of the present invention.

FIG. 7B depicts a distribution for α_{if} for different cache sizes under the TPCC workload in accordance with an embodiment of the present invention.

FIG. 7C depicts a distribution for αₛₜ for different cache sizes under the TPCC workload in accordance with an embodiment of the present invention.

FIG. 7D depicts a distribution for α_{ld} for different cache sizes under the SPECJBB workload in accordance with an embodiment of the present invention.

FIG. 7E depicts a distribution for α_{if} for different cache sizes under the SPECJBB workload in accordance with an embodiment of the present invention.

FIG. 7F depicts a distribution for αₛₜ for different cache sizes under the SPECJBB workload in accordance with an embodiment of the present invention.

Table 1 summarizes relative errors of the simulation results from the abstraction model in comparison to simulation results from a cycle-accurate simulation from executing TPCC workload in accordance with an embodiment of the present invention.

Table 2 summarizes relative errors of the simulation results from the abstraction model in comparison to simulation results from a cycle-accurate simulation from executing SPECJBB workload in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Exemplary Computer System

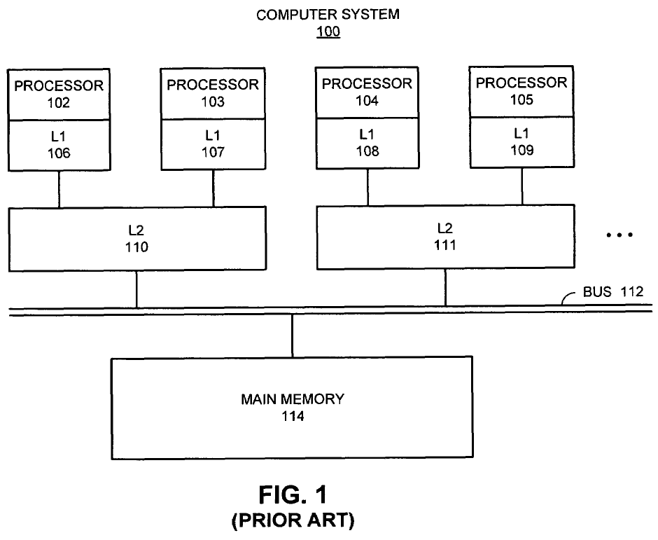

FIG. 1 illustrates an exemplary computer system 100 which is to be modeled in accordance with an embodiment of the present invention. Computer system 100 includes a number of processors 102-105, which are coupled to respective level 1 (L1) caches 106-109. (Note that L1 caches 106-109 can include separate instruction and data caches.) L1 caches 106-109 are coupled to level 2 (L2) caches 110-111. More specifically, L1 caches 106-107 are coupled to L2 cache 110, and L1 caches 108-109 are coupled to L2 cache 111. L2 caches 110-111 are themselves coupled to main memory 114 through bus 112.

Note that the present invention can generally be used to simulate the performance of any type of computer system and is not meant to be limited to the exemplary computer system illustrated in FIG. 1.

### Constructing Statistical Distributions for the Model

Defining the Statistical Distributions

A modem computer-system-memory can service multiple memory requests concurrently. Given enough processor and system resources (such as the instruction scheduling window or the load queue size) coupled with some inherent parallelism of the workload, some of the actual memory references can be overlapped, thereby reducing the effects of memory-system-latency on system performance. In particular, studies show that cache misses get overlapped due to their burstiness in an out-of-order processor. This overlap can take a variety of forms. Some cache misses may be overlapped almost entirely, some may overlap just barely, and there may be any number of the cache misses, all overlapped to some extent. Hence, to fully characterize the overlap between cache misses, we need to take into account not only the mean value of the overlap, but also its variation.

In one embodiment of the present invention, a memory-system model comprises two sets of statistical distributions associated with each of the following three memory reference types: loads, instruction fetches, and stores. The first set of triple statistical distributions, designated as α_{ld}, α_{if}, and αₛₜ (i.e., α distributions), characterize distances between consecutive cache misses of each type, respectively. Note that these distributions can be used to characterize the bursty miss behavior described above. Also note that smaller distances between consecutive misses make them easier to overlap. In one embodiment of the present invention, the cache misses are specifically directed to L2 cache misses.

In one embodiment of the present invention, we express distances in units of instructions or memory references (hits or misses) instead of wall clock time. This is convenient because wall clock time typically includes processor stall time, which is dependent on memory-interconnect-latencies. Consequently, if wall clock time were used, the distances would have to be corrected for any constituent stall time. In contrast, because no instructions or memory references are issued during stall periods, using instructions or memory references to measure distances obviates the need for such correction. On the other hand, memory-interconnect-latencies and system response time are measured in wall clock time or processor clock cycles.

Note that the α distributions are typically dependent on memory-system configurations. For example, changes to the L2 cache miss rates (e.g., via sharing or the number of threads in the system) can clearly change these distributions. Because the α distributions for the abstraction model are obtained from a specific memory-system configuration (which is described in details below), the actual α distributions (α′ distributions) used to simulate each new memory-system configuration are obtained from the α distributions either by resealing the α distributions to match the total miss rate of the new memory-system configuration (as is detailed below) or by using a cache simulation.

The second set of triple statistical distributions, designated as τ_{ld}, τ_{if}, and τₛₜ, characterize the distance between a cache miss of each type and the beginning of a stall period caused by that miss, respectively. We define a processor stall as the state in which the functional units are completely idle, and no further instructions of any type can be retired or issued until the miss is returned. Hence, these τ distributions summarize the amount of time that the processor is able to execute past a miss. Larger τ values facilitate looking farther ahead for miss overlapping opportunities. We look at each abstraction in more detail below.

The first abstraction τ_{ld} summarizes the distance between the point when a load miss occurs and the point when the result associated with the load is required to avoid stalling.

A “demand instruction miss” stalls the processor immediately. In the case of a processor that prefetches instructions, the abstraction τ_{if} summarizes the distance between the prefetch and the would-be demand miss. In particular, this shows how the proposed framework handles prefetches.

Note that a store miss typically stalls a processor only if it causes the store buffer to become full. Hence, abstraction τₛₜ summarizes the distance between a store miss and the time when the store buffer fills up. Note that τₛₜ may be slightly sensitive to the memory-system interconnect configuration depending on the specific mechanism that is used to handle the stores and the specific memory-consistency model that is used.

The six distributions described above provide a basis for understanding cache miss behavior of the processor.

Additionally, because the distances are measured in the number of instructions or memory references while memory latencies and system response time are measured in processor clock cycles, it is necessary to provide a conversion between the two measurement metrics. One embodiment of the present invention provides a conversion factor s_{inf} for the model, wherein s_{inf} represents the rate of execution in cycles per instruction (CPI) or cycles per reference. More specifically, s_{inf} is obtained for an infinite (L2) cache when the processor is not stalled. Note that infinite cache CPI is a standard parameter used in many system models (see Sorin, D., Pai, V., Adve, S., Vernon, M., and Wood, D. 1998, “Analytic Evaluation of Shared-Memory Systems with LP Processors,” In Proceedings of the 25th International Symposium on Computer Architecture, 380-391).

Obtaining the Statistical Distributions

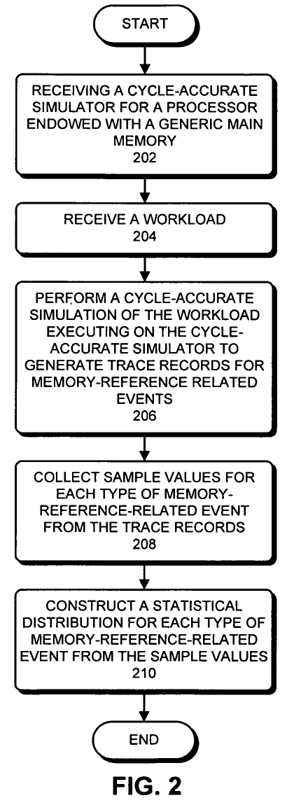

The abstraction components α and τ for the high-level model are obtained empirically by performing a trace-driven simulation on a full-scale computer system model. More specifically, FIG. 2 presents a flowchart illustrating the process of producing the statistical distributions for a high-level computer system model in accordance with an embodiment of the present invention.

The system starts by receiving a cycle-accurate simulator for a processor endowed with a generic memory (step 202). In this model, we assume that the L1 cache configuration is fixed and a cache miss refers to an L2 cache miss unless noted otherwise. We also assume that the L2 cache latency is fixed.

Next, the system receives a workload which comprises a set of traces, wherein each trace comprises a sequence of memory references (step 204). Note that a given workload can include millions of memory references. In one embodiment of the present invention, the workload is a benchmark used to evaluate computer system performance.

The system then applies the workload to the computer system model to simulate the actual execution of the processor that is being modeled (step 206). Specifically, the system performs a cycle-accurate simulation of the workload executing on the cycle-accurate simulator, which generates trace records corresponding to different memory-reference-related events. In particular, the cycle-accurate simulation generates miss traces for each type of cache misses. For example, a miss trace for a load can include all of the following: the memory reference type (i.e., load), the cache/memory level that supplied the data (e.g., DRAM), the start and finish times of the load miss, and the duration of a stall period (if the miss causes a stall).

Note that because the traces record memory-reference-related events as opposed to other instructions, one embodiment of the present invention measures distances in units of memory references. Alternatively, a trace can maintain an instruction count for each reference it records.

Next, the system collects a set of sample values from the traces for each type of memory-reference-related events (step 208). Specifically, to record sample values for the α distributions, the system records the number of memory references from the trace between consecutive cache misses of the corresponding type. For example, assuming that references are sorted according to their start times, if references 1,005 and 1,017 are consecutive load misses, the system adds 1,017−1,005=12 (memory references) to the α_{ld} samples. Similarly, a τ sample value is obtained by recording the number of memory references that fall between the start of a cache miss and the beginning of a stall period caused by the cache miss.

Note that during the process of sample collection, if coalesced memory references directed to a same cacheline generate a cluster of miss traces, only the earliest miss trace in the cluster should be collected.

The system next constructs a statistical distribution for each type of memory-reference-related event based on the collected sample values (step 210). One embodiment of the present invention constructs a percentile distribution from the collected sample values based on their magnitude (in number of memory references). Hence, each sample value is ranked to a percentile value between (0%, 100%), which can be referred to as the frequency of this sample value. Note that multiple occurrences of a same sample value are ranked separately. This facilitates sampling from this percentile distribution during modeling. We describe how to use these statistical distributions to model different memory-system configurations below.

### Simulating a Given Memory System Using the Statistical Distributions

Illustrative Description of the Simulation Process

We now describe how to simulate the execution of a workload on a given memory-system design by using the abstractions of α′, τ, and s_{inf}.

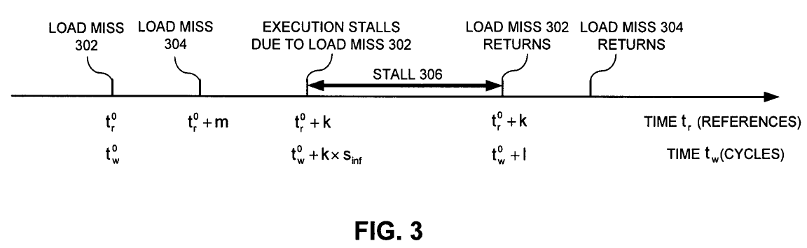

FIG. 3 illustrates a simulated execution trace on a modeled memory-system configuration in accordance with an embodiment of the present invention.

For this memory-system configuration, we assume that we know the cache miss rates per memory reference for each memory reference type. We also assume that we know various hardware latencies (e.g., L3 latency, main memory latency, etc.) which describe the memory-system interconnect, wherein the latencies are measured in wall clock time units (e.g., in processor cycles). Typically, these latencies are sums of hardware latencies and queuing delays. During the simulation, we maintain both a memory reference time tᵣ and a wall clock time t_{w} as shown in FIG. 3.

We generate load misses for this illustration. Specifically, L2 cache misses are generated using the interarrival distributions α′. Note that if a first L2 load miss 302 takes place at time (tᵣ⁰; t_{w}⁰), a next L2 load miss 304 would occur at time tᵣ=tᵣ⁰+m (see FIG. 3), where m is obtained by sampling from the distribution α′_{ld}, m ∈ α′_{ld}. In one embodiment of the present invention, the α′distributions are percentile distributions which are generated in the manner described above, and sampling from the α′distributions involves randomly selecting a value from the corresponding percentile distributions. Note that instruction fetch and store misses can be generated analogously using α′_{lf}, α′ₛₜ distributions, respectively. Also note that the miss processes corresponding to different memory reference types are statistically independent in time tᵣ, and evolve in the same time frame (tᵣ; t_{w}).

Because we know the various cache miss rates, each L2 miss can be probabilistically chosen to hit at a particular memory-system component (e.g., a L3 hit, a memory hit, a remote L2 hit, etc.), thereby allowing determining the latency l corresponding to that L2 cache miss.

Next, we determine the stall for the first load miss 302 using the τ_{ld} distribution. For example, load miss 302 issued at time (tᵣ⁰; t_{w}⁰) causes a stall 306 at tᵣ=tᵣ⁰+k (see FIG. 3), that is, k references after miss 302 is issued if load miss 302 is still outstanding by then, where k is sampled from τ_{ld}, k ∈ τ_{ld}. To determine whether stall 306 actually takes place, we need to compare k to the latency l. More specifically, we first calculate the wall clock start time t_{w} associated with stall 306. Because the rate of issuing memory references is s_{inf} and k memory references are issued since the miss, then t_{w}=t_{w}⁰+k×s_{inf}. In order for the stall to take place, t_{w} needs to be less than t_{w}⁰+l, because the latter time represents when the miss is returned after a hit. As is illustrated in FIG. 3, stall 306 indeed occurs because k×s_{inf}<l. Note that at the end of stall 306 tᵣ remains tᵣ⁰+k because no references are issued during this stall period. However, t_{w} has advanced from t_{w}⁰+k×s_{inf} to t_{w}⁰+l in terms of wall clock time. Although not shown in FIG. 3, it is apparent that miss 302 will not cause a stall if k×s_{inf}>l.

Referring to FIG. 3, because the second miss 304 takes place at tᵣ=tᵣ⁰+m and m<k, some of the service of later miss 304 is overlapped with the service of early miss 302. On the other hand, if m>k, latter miss 304 is issued only after early miss 302 is returned.

To determine an appropriate action if m=k, we note that a stall period corresponding to k references in the τ_{ld} distribution effectively starts between the kth and the (k+1)th reference after the original miss. That is, the kth reference occurs before the stall begins. Hence, when m=k, the second miss is issued prior to the stall and the stall time is overlapped with servicing this later miss. At the end of the stall period, tᵣ remains to be tᵣ⁰+k because no references are issued during the stall period. This observation also applies to instruction fetches and store misses, which are modeled analogously.

Note that during a stall period, all outstanding misses of any reference type are serviced concurrently. In particular, the miss processes corresponding to different reference types are now dependent when observed in time t_{w}. It would be apparent to one of ordinary skill in the art that larger interconnect latencies impact simulation estimates by increasing the duration of stall periods. Furthermore, larger L2 cache miss rates pack more misses in front of a stall, which potentially allows for greater miss overlap while causing more frequent stalls.

We now describe how to obtain α′distributions from the abstraction distributions α. Note that the mean values of the α distributions are reciprocals of the corresponding known miss rates. For a given new memory-system configuration, we use rescaled versions of α, so that the implied miss rates corresponding to the rescaled distributions α′ match the miss rates for the modeled interconnect. Again using loads as an example, the corrected distributions α′_{ld} can be effectively obtained by applying a stretching factor of m_{L2ld}/m′_{L2ld} to α_{ld}, where m′_{L2ld} and m_{L2ld} are the total L2 load miss rates for the new and the generic memory-system configurations, respectively.

In another embodiment of the present invention, an exponential resealing technique can be used to obtained α′ from α. Specifically, given samples x_{1,} . . . , xₙ from α_{ld}, we numerically find an exponent ρ, such that

$${\sum }_{i = 1}^{n} [ {( 1 + {x}_{i} )}^{ρ} - 1 ] / n = 1 / {m}_{L 2 ld}^{′} ,$$

and then use (1+x₁)^{ρ}−1, . . . , (1+xₙ)^{ρ}−1 as the new samples for α′. This technique may be more intuitive because the logarithmic scale for miss rates and interarrival distances is often considered natural (see Gluhovsky, I. and O.Krafka, B. W., “Comprehensive Multiprocessor Cache Miss Rate Generation Using Multivariate Models,” ACM Transactions on Computer Systems 23(2), 111-145, 2005).

In yet another embodiment of the present invention, distributions α′ can be obtained through cache simulations of memory-system configurations of interest. Note that the same cache simulation can be used to obtain cache miss rates for these different memory-system configurations.

We now look into a particular detail of how we estimate the τ distributions. Note that there are some memory references which do not cause stalls in the trace. This behavior is expected for many stores and other memory references that coalesce to the same cache line which is associated with other stalling references. However, there are a number of scenarios where a reference does not cause a stall in the trace, but would cause a stall if we could observe execution long enough after the reference had been issued without interruptions from other references.

For example, suppose that load miss 302 in FIG. 3 is followed closely by load miss 304 and then causes a stall as shown in FIG. 3. Because a considerable portion of time of servicing miss 304 is overlapped with the time of servicing miss 302, miss 304 may not cause a stall (as it returns shortly after resumption of execution) (see FIG. 3). However, if miss 302 had been a hit, miss 304 would have caused a stall. The conclusion we draw is that we observe τ samples which are biased downwards. Indeed, had miss 304 caused a stall before miss 302 did, it would have been observed instead. Thus, in that situation, we observe a quicker stall and not a slower one.

We can correct for this bias by using the Kaplan-Meier technique for censored data (see Kaplan, E. L. and Meier P., “Non-Parametric Estimation from Incomplete Observations,” Journal of the American Statistical Association, 53, 457-481, 1958). More specifically, for each reference we record the τ time if it is observed. If it is not observed, we record the number of references issued while the miss is outstanding and annotate it to signify that the τ time is at least as large as the recorded number. This data provides standard input to the Kaplan-Meier technique.

Process of Simulating the Given Memory-System Configuration

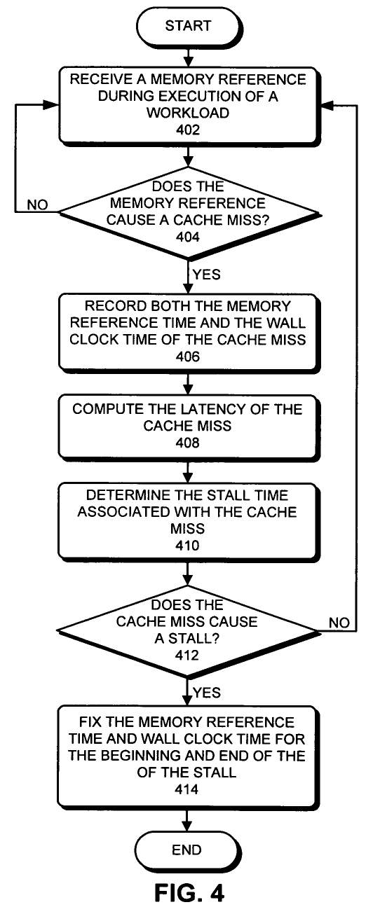

FIG. 4 presents a flowchart illustrating the process of simulating the execution of a workload on a modeled memory-system configuration in accordance with an embodiment of the present invention. Again, we assume that cache miss rates and hardware latencies associated with the interconnect configuration are known for the simulation. Note that both the cache miss rates and hardware latencies can be obtained from a cache simulation.

The system starts by receiving a memory reference during execution of a given workload (step 402). The system then determines if the memory reference generates a cache miss (step 404). If not, the memory reference returns to the processor, and the system returns to step 402 to process the next memory reference. Otherwise, if the memory reference generates a cache miss, the system records both the memory reference time and the wall clock time when the cache miss occurs (step 406).

Next, the system computes the latency l (in wall clock time) of the cache miss based on the cache miss rates (step 408). Specifically, computing the latency involves probabilistically choosing a particular component in the memory system which is ultimately accessed by the cache miss based on the cache miss rates.

The system then determines a stall time associated with the cache miss (step 410). Specifically, the system determines the stall time (k) by sampling the corresponding τ distribution associated with the memory reference type. In one embodiment of the present invention, sampling the τ distribution involves randomly selecting a number from a percentile ranked τ distribution, wherein the percentile distribution was generated using the method described above.

The system then determines if the stall actually occurs by comparing wall clock times k×s_{inf} (wherein s_{inf} is the infinite cache CPI) and l (step 412). If not, the memory reference returns before the stall, and the system returns to step 402 to process the next memory reference.

Otherwise, if the stall due to the cache miss indeed occurs, the system fixes the memory reference time and wall clock time for the beginning and the end of the stall (step 414).

Note that based on the above simulation process, we know the exact time of the current cache miss in memory reference time. We can then determine the next memory reference that would generate a next cache miss. This is achieved by sampling from a corresponding α′ distribution in a manner similar to sampling the τ distribution.

### Examples of Simulating Actual Systems

We evaluate the abstraction model by applying it to a 2.8 GHz AMD Opteron™ processor running TPCC and SPECJBB workloads. In doing so, we show that the abstraction model remains latency invariant for the both workloads. More specifically, we perform a cycle-accurate simulation of the Opteron processor endowed with a 1 MB L2 cache and the main memory (DRAM), wherein the latency of the main memory is varied. Four DRAM latency levels are considered: 1 ns, 11 ns, 30 ns, and 190 ns. The corresponding average load-to-use system latencies are 58 ns, 68 ns, 87 ns, and 247 ns, respectively.

Note that the columns in the middle of Table 1 and Table 2 represent the rate of execution s_{inf} for the four different memory latencies for TPCC and SPECJBB respectively in cycles per reference. We conclude that the variations of s_{inf} are negligible.

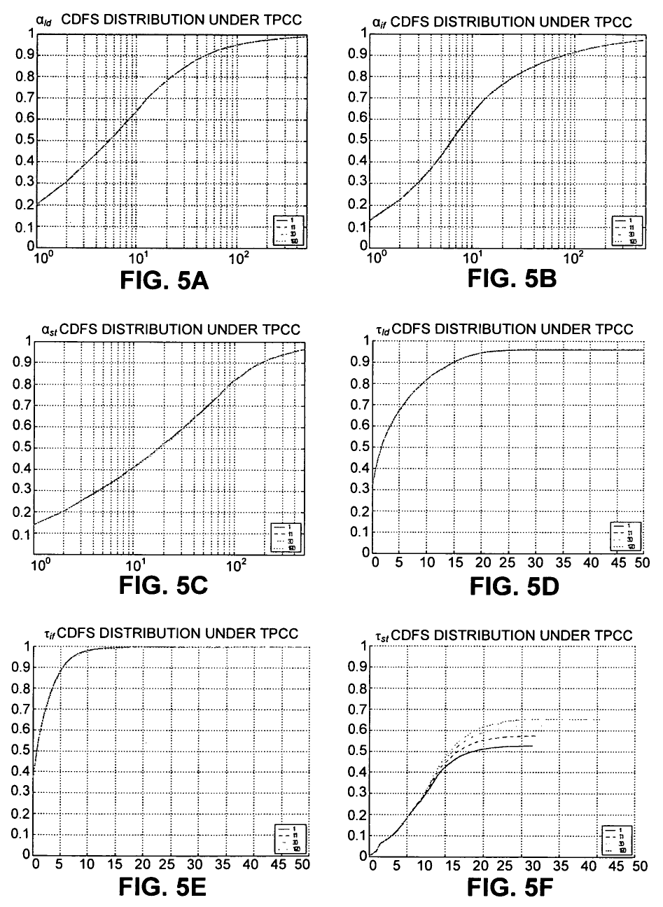

FIGS. 5A-5F depict cumulative distribution functions (cdfs) of the α and τ distributions for the three memory reference types and four different memory latencies under the TPCC workload in accordance with an embodiment of the present invention.

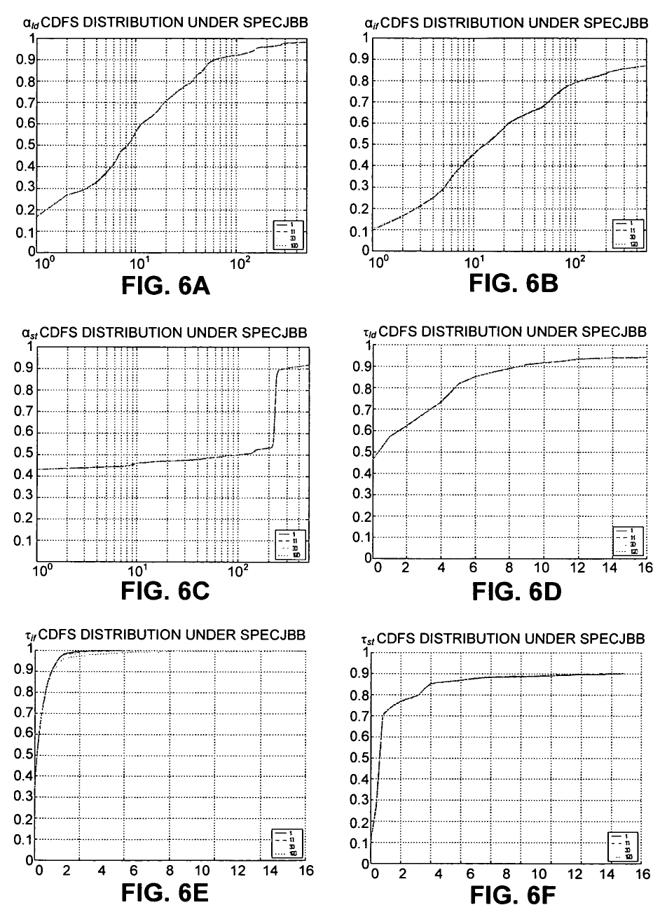

FIGS. 6A-6F depict cumulative distribution functions (cdfs) of the α and τ distributions for the three memory reference types and four different memory latencies under the SPECJBB workload in accordance with an embodiment of the present invention.

Note that the logarithmic horizontal scale is used for the α distribution graphs. Also note that on each graph, cdfs corresponding to the four different memory latencies are overlaid. In the case of τₛₜ, the graphs do not reach the ordinate of one because a nonnegligible percentage of stores does not cause a stall. It is easily seen that latency changes cause indistinguishable differences to five TPCC distributions and all SPECJBB distributions.

TPCC distribution τₛₜ as illustrated in FIG. 5F shows light sensitivity to latency for large distances while still being invariant for small distances. When we multiply the upper bound of the interval of agreement among the four curves in FIG. 5F (about x_{α}=17) by the rate of execution,

$$\frac{{x}_{a} \times {s}_{inf}}{2.8 GHz} = \frac{17 refs \times 7.20 cycles \text{/} ref}{2.8 cycles \text{/} ns} = 44 ns ,$$

we get close to the smallest system latency considered (58 ns). Hence, we reach an agreement in the common region of observation. A simple remedy for this problem is to use a τₛₜ which corresponds to a large latency (e.g. 247 ns) in the abstraction. We do not find this problem in the case of SPECJBB where a very small percentage of stores causes stalls after 58 ns (see FIG. 6F).

### Comparing the Model with Cycle-Accurate Simulation

We compare the model results with results given by cycle-accurate simulation. Let r_{ld,l}^{mod,l′} be the number of L2 load misses issued per second in a system with memory latency l′ which is computed by the model when using the abstraction that corresponds to memory latency l. That is, the abstraction is computed using a trace from simulating a system with latency l.

We then use this abstraction to model a system with a possibly different latency l′. Furthermore, let r_{ld,l}^{sim} be the corresponding quantity given by the cycle-accurate simulation of a system with latency l. First, we use the same latency l for both the abstraction and the modeled system.

Table 1 summarizes relative errors of the simulation results from the abstraction model in comparison to simulation results from a cycle-accurate simulation from executing TPCC workload in accordance with an embodiment of the present invention.

Table 2 summarizes relative errors of the simulation results from the abstraction model in comparison to simulation results from a cycle-accurate simulation from executing SPECJBB workload in accordance with an embodiment of the present invention.

The load column in the left half of Table 1 represents TPCC ratios r_{ld,l}^{mod,l′}/r_{ld,l}^{sim} for the four latencies under consideration. The instruction and store column entries are defined analogously.

The left half of Table 2 contains the corresponding numbers for SPECJBB. We observe that the errors range from 0% to 3%, which indicates that the abstraction captures most of the important information about the processor as it impacts system performance.

Next, we investigate the effect of using a fixed abstraction to model systems with different latencies. This ability is important because our goal is to model a variety of memory-system configurations with a single processor abstraction. Because latency invariance of the abstraction primitives has already been shown, we do not expect any notable changes in the model accuracy. The right halves of Tables 1 and 2 present ratios r_{ld,247}^{mod e,l′}/r_{ld,l}^{sim} for the two workloads respectively. That is, we use the same abstraction obtained for the average memory latency l=247 ns (corresponding to setting the DRAM latency to 190 ns) to model systems with the other three latencies. Note that, we observe similar small errors.

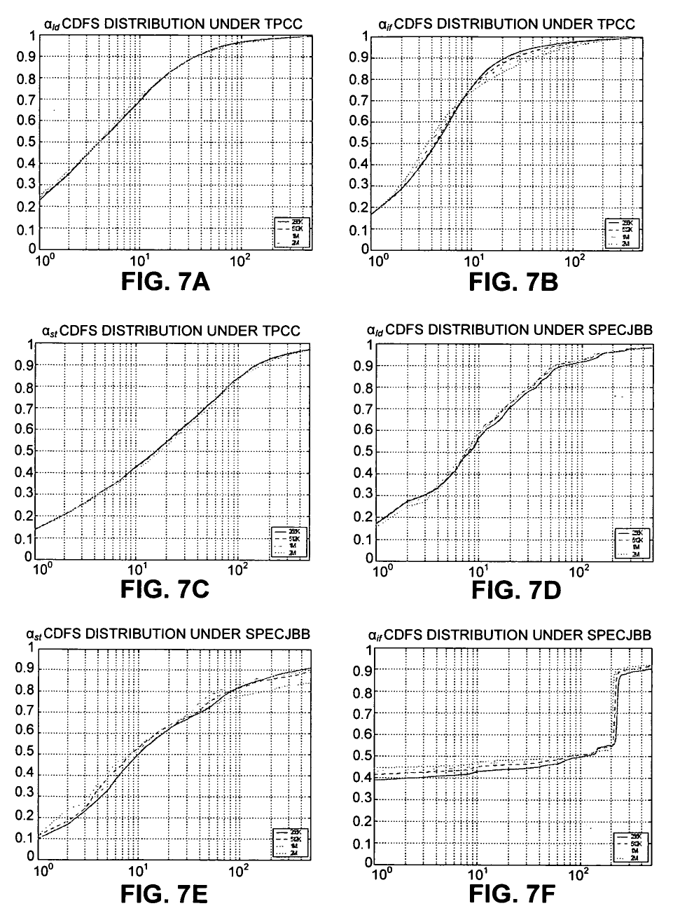

Finally, we vary the size of the L2 cache between 256 KB and 2 MB to show that the abstraction is insensitive to changes in the cache configuration. FIGS. 7A-7F depict the a distributions for both TPCC and SPECJBB workloads and the four cache sizes of 256 KB, 512 KB, 1 MB, and 2 MB in accordance with an embodiment of the present invention. The distributions are exponentially rescaled as described above for modeling the 256 KB cache. Results for modeling the other cache sizes are qualitatively very similar. Despite slight variations, the errors incurred when using a unique abstraction to model systems with different cache sizes are in the same range as the errors in Tables 1 and 2 (up to 4%) and are not listed. Also, recall that these distributions can be obtained through cache simulation for each cache configuration separately. The τ distributions demonstrate similar agreement and are not plotted.

Note that the proposed abstraction is also insensitive to changes to other types of cache configuration, which include, but are not limited to: the number of cache levels, cache parameters (e.g., size, associativity, sharing), cache-coherence protocol used, NUMA (nonuniform memory access) interconnect used, and directory-based lookup.

### CONCLUSION

The present invention provides a technique for modeling computer system performance by using a generic high-level system model. In comparison to the existing modeling techniques, the present invention provides a number of advantages.

First, the model abstraction is portable and can therefore be used in a variety of system modeling contexts rather than being hardwired into a specific modeling methodology.

Second, the present invention abstracts the processor activity that is relevant for performance modeling. In particular, this model probabilistically models cache miss overlaps for different types of cache misses, processor stalls, and miss burstiness. Note that we do not need to make approximations or questionable assumptions for invariances that are typical in existing models. Instead, we find the invariances that are inherent to system behavior, which are intuitive and present a compact description of the interaction of the processor and the memory subsystem. At the same time, the invariances can be used to provide extremely accurate estimates of system performance.

Third, the present invention permits straightforward extensions to account for advanced architectural features, which can include: instruction prefetching, data prefetching, and speculative activity during stall periods referred to as runahead execution. For example, we modeled instruction prefetching in an Opteron processor within the same framework. Furthermore, the model permits efficient assessment of benefits of these architectural features. More specifically, the model provides insights into the way the architectural features improve performance by generating a process that is typical of the new execution pattern. In the instruction prefetch example, it would be straightforward to determine stochastically how many other misses can be overlapped with a prefetched instruction miss, which would otherwise stall the processor immediately.

Finally, the same abstraction is suitable for modeling any computer system configuration, including: multiprocessor systems, memory subsystems with different number of levels of cache hierarchy, different cache configuration in each cache level (e.g., cache size, cache associativity, cache sharing), and various cache-coherence protocols, nonuniform memory access (NUMA) interconnects, and directory-based lookup. Moreover, the abstraction primitives can be obtained by parsing through a single trace obtained from single core simulation.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

TABLE 1

| latency | load | i-fetch | store | s_{inf} | latency | load | i-fetch | store |
|---|---|---|---|---|---|---|---|---|
| 1 | 1.01 | 1.02 | 1.00 | 4.57 | 1 | 1.03 | 1.00 | 1.03 |
| 11 | 1.01 | 1.02 | 1.01 | 4.57 | 11 | 1.02 | 1.00 | 1.03 |
| 30 | 1.01 | .99 | 1.01 | 4.59 | 30 | 1.02 | 1.00 | 1.02 |
| 190 | .98 | .99 | .99 | 4.67 | | | | |

TABLE 2

| latency | load | i-fetch | store | s_{inf} | latency | load | i-fetch | store |
|---|---|---|---|---|---|---|---|---|
| 1 | 1.03 | 1.03 | 1.03 | 7.20 | 1 | 1.03 | 1.01 | 1.04 |
| 11 | 1.03 | 1.03 | 1.03 | 7.25 | 11 | 1.03 | 1.01 | 1.04 |
| 30 | 1.02 | 1.02 | 1.02 | 7.35 | 30 | 1.01 | 1.00 | 1.02 |
| 190 | 1.00 | 0.99 | 1.00 | 7.25 | | | | |

What is claimed is:

1. A method for modeling computer system performance, the method comprising:
empirically obtaining a statistical model which comprises sets of statistical distributions for at least two types of memory-reference-related events associated with a workload executing on a processor in a computer system, wherein the sets of statistical distributions include:
a first set of statistical distributions which characterize a distance between consecutive cache misses; and
a second set of statistical distributions which characterize a distance between a cache miss and the beginning of a processor stall caused by the cache miss; and
using the statistical model to simulate the performance of the computer system executing the workload.

2. The method of claim 1, wherein empirically obtaining the sets of statistical distributions involves:
receiving a cycle-accurate simulator for the processor endowed with a generic main memory;
performing a cycle-accurate simulation of the workload executing on the cycle-accurate simulator to generate trace records for the memory-reference-related events;
collecting a set of sample values for each type of memory-reference-related event from the trace records; and
constructing a statistical distribution for each type of memory-reference-related event from the set of sample values.

3. The method of claim 2, wherein constructing the statistical distribution from the set of sample values involves ranking the set of the sample values into a percentile distribution based on the magnitude of the sample values.

4. The method of claim 3, wherein using the statistical model to simulate the performance of the computer system executing the workload involves randomly sampling from the percentile distribution.

5. The method of claim 2, wherein using the statistical model to simulate the performance of the computer system executing the workload involves randomly sampling from the set of sample values.

6. The method of claim 1, wherein each set of statistical distributions includes statistical distributions for different types of memory references including:
loads;
instruction fetches; and
stores.

7. The method of claim 1, wherein prior to using the statistical model to simulate the performance of the computer system, the method further comprises rescaling the first set of statistical distributions for a new memory-subsystem configuration.

8. The method of claim 1, wherein using the statistical model to simulate the performance of the computer system executing the workload involves:
sampling from the first set of statistical distributions to generate simulated cache misses;
computing latencies for the simulated cache misses; and
sampling from the second set of statistical distributions and using the computed latencies to determine stall times associated with the simulated cache misses.

9. The method of claim 8, wherein computing the latency associated with a cache miss involves:
obtaining cache miss rates for specific components in the memory subsystem of the computer system;
using the cache miss rates to select a specific component in the memory subsystem which is ultimately accessed by the cache miss; and
computing the latency based on the latency of the specific component.

10. The method of claim 1, further comprising using the obtained statistical model to simulate a multiprocessor with different memory-subsystem configurations, wherein the different memory-subsystem configurations can differ in at least one of the following:
number of cache levels;
cache configuration in each cache level, which can include:
cache size;
cache associativity; or
cache sharing;
cache-coherence protocol;
nonuniform memory access (NUMA) interconnect; and
directory-based lookup.

11. The method of claim 1, further comprising using the obtained statistical model to simulate a multiprocessor implementing advanced architectural designs including:
instruction prefetching;
data prefetching; and
runahead execution.

12. The method of claim 1, further comprising using the obtained statistical model to reproduce processor behavior whose stochastic characteristics match real execution.

13. The method of claim 1, wherein empirically obtaining the statistical model further comprises obtaining a rate of execution of the processor in cycles per instruction (CPI).

14. The method of claim 1, wherein prior to using the statistical model, the method further comprises correcting the second set of statistical distributions for censored data using a Kaplan-Meier technique.

15. A computer-readable storage medium storing instructions that when executed by a computer cause the computer to perform a method for modeling computer system performance, the method comprising:
empirically obtaining a statistical model which comprises sets of statistical distributions for at least two types of memory-reference-related events associated with a workload executing on a processor in a computer system, wherein the sets of statistical distributions include:
a first set of statistical distributions which characterize a distance between consecutive cache misses; and
a second set of statistical distributions which characterize a distance between a cache miss and the beginning of a processor stall caused by the cache miss; and
using the statistical model to simulate the performance of the computer system executing the workload.

16. The computer-readable storage medium of claim 15, wherein empirically obtaining the sets of statistical distributions involves:
receiving a cycle-accurate simulator for the processor endowed with a generic main memory;
performing a cycle-accurate simulation of the workload executing on the cycle-accurate simulator to generate trace records for the memory-reference-related events;
collecting a set of sample values for each type of memory-reference-related event from the trace records; and
constructing a statistical distribution for each type of memory-reference-related event from the set of sample values.

17. The computer-readable storage medium of claim 16, wherein constructing the statistical distribution from the set of sample values involves ranking the set of the sample values into a percentile distribution based on the magnitude of the sample values.

18. The computer-readable storage medium of claim 17, wherein using the statistical model to simulate the performance of the computer system executing the workload involves randomly sampling from the percentile distribution.

19. The computer-readable storage medium of claim 16, wherein using the statistical model to simulate the performance of the computer system executing the workload involves randomly sampling from the set of sample values.

20. The computer-readable storage medium of claim 15, wherein each set of statistical distributions includes statistical distributions for different types of memory references including:
loads;
instruction fetches; and
stores.

21. The computer-readable storage medium of claim 15, wherein using the statistical model to simulate the performance of the computer system executing the workload involves:
sampling from the first set of statistical distributions to generate simulated cache misses;
computing latencies for the simulated cache misses; and
sampling from the second set of statistical distributions and using the computed latencies to determine stall times associated with the simulated cache misses.

22. The computer-readable storage medium of claim 21, wherein computing the latency associated with a cache miss involves:
obtaining cache miss rates for specific components in the memory subsystem of the computer system;
using the cache miss rates to select a specific component in the memory subsystem which is ultimately accessed by the cache miss; and
computing the latency based on the latency of the specific component.

23. An apparatus that models computer system performance, comprising:
a measurement mechanism configured to empirically obtain a statistical model which comprises sets of statistical distributions for at least two types of memory-reference-related events associated with a workload executing on a processor in a computer system, wherein the sets of statistical distributions include:
a first set of statistical distributions which characterize a distance between consecutive cache misses; and
a second set of statistical distributions which characterize a distance between a cache miss and the beginning of a processor stall caused by the cache miss; and
a simulation mechanism configured to use the statistical model to simulate the performance of the computer system executing the workload.

24. The apparatus of claim 23, wherein the measurement mechanism is configured to:
receive a cycle-accurate simulator for the processor endowed with a generic main memory;
perform a cycle-accurate simulation of the workload executing on the cycle-accurate simulator to generate trace records for the memory-reference-related events;
collect a set of sample values for each type of memory-reference-related event from the trace records; and to
construct a statistical distribution for each type of memory-reference-related event from the set of sample values.

25. The apparatus of claim 23, wherein the simulation mechanism is configured to:
sample from the first set of statistical distributions to generate simulated cache misses;
compute latencies for the simulated cache misses; and to
sample from the second set of statistical distributions and using the computed latencies to determine stall times associated with the simulated cache misses.
